(19) United States
(12) Patent Application Publication
(10) Pub. No.: US 2026/0174264 A1
(43) Pub. Date: Jun. 25, 2026

(54) ARTIFICIAL CHRISTMAS TREE INTEGRATED WITH A CAT TOWER

(71) Applicant: Stephen O’Neill, Waltham, MA (US)

(72) Inventor: Stephen O’Neill, Waltham, MA (US)

(21) Appl. No.: 19/541,612

(22) Filed: Feb. 17, 2026

Related U.S. Application Data
(63) Continuation-in-part of application No. 19/233,162, filed on Jun. 10, 2025.
(60) Provisional application No. 63/658,529, filed on Jun. 11, 2024.

(51) Int. Cl. A47G 33/06; A01K 15/02

(52) U.S. Cl. CPC A47G 33/06; A01K 15/025

(57) ABSTRACT

The present invention discloses an artificial Christmas tree integrated with a cat tower. The Christmas tree comprises a trunk having a climbing structure and a decorative assembly. The climbing structure defines a pathway extending along a length of the trunk. The pathway enables the cat to move along the length of the trunk. The decorative assembly is configured to simulate at least one of the foliage, branches, and ornamental structures. The trunk is dimensioned to allow at least one cat to move over at least one of the interior side and the exterior side of the trunk.

### CROSS REFERENCE TO RELATED APPLICATIONS

The present application is a continuation-in-part of the U.S. patent application Ser. No. 19/233,162, entitled “Artificial Christmas tree integrated with a cat tower” filed on Jun. 10, 2025, which claims the priority benefit of the U.S. Patent Application No. 63/658,529 filed on Jun. 11, 2024, the contents of which are hereby incorporated by reference in their entirety.

### TECHNICAL FIELD

The present invention generally relates to an artificial Christmas tree. More specifically, the present invention relates to an artificial Christmas tree integrated with a cat tower.

### BACKGROUND

Pet owners with Christmas trees encounter constant challenges during the holiday season. In particular, cats are known for their fascination for the features of the Christmas trees including both artificial and natural Christmas trees. The artificial Christmas tree typically comprises a metal frame containing a base stand, a center pole projecting vertically from the center of the base and tree branches attached to the center pole. The tree branches are decorated with ornaments such as shiny baubles, tinsel, and other reflective decorations, and dangling decorations. The dangling decorations mimicking the movements of small animals or birds, and shiny and reflective ornaments appeals to the cats' instincts and draws cats to the Christmas tree. Further, the structure of the Christmas tree provides an enticing climbing challenge and appeals to the cat's instinct to explore different heights.

Further, real Christmas trees introduce new scents and textures into the home. The pine or fir smell is intriguing, which prompts cats to sniff, rub, and sometimes chew on the branches. As a result, ornaments are knocked over and broken, and lights are chewed, which poses a risk of electrocution. Sometimes, the tree itself is toppled, which leads to a mess and potential damage to furniture and other household items. Some cats are also attracted to the taste and smell of the tree materials, including real or artificial tree materials, which leads the cats to chew on the branches or needles. Thus, the features of the Christmas tree require the cat owners to constantly monitor their cats and keep the cats away from the tree, which could be exhausting and diminish the joy of Christmas celebrations.

Additionally, dismantling and storing artificial trees after the holiday season can be cumbersome, as the tree parts may be heavy and difficult to fit into containers or cartons without risking damage. Further, the cats might destroy the Christmas tree by trying to reach the ornaments that are present on the Christmas tree.

U.S. Pat. No. 6,458,435 assigned to Jimmy Kam-Wing Lai, entitled “Artificial tree” discloses an artificial tree having a central trunk, a number of main branches suspended from an upper portion of the trunk in a downwardly and outwardly inclined orientation, and a preformed tree top section extending upwardly from the upper portion of the trunk. Each main branch includes a number of sub-branch clusters and a bundle of fiber optic conduits which terminate in the sub-branches. The bundles of Fiber optic conduits are received in an opaque enclosure housing a high intensity light source, which enclosure is attached to the upper portion of the trunk. Electric lights are disclosed as an alternative means to illuminate the tree. The trunk includes upwardly open hook elements which receive pin elements within the interior of rigid support members of the main branches. Each sub-branch cluster is pivotally connected to an associated rigid support member to articulate between a collapsed position for storage and shipping, and an extended position for display.

U.S. Pat. No. 6,116,563 assigned to Yuan-Hui Tsai, entitled “Christmas tree with improved branch joint” discloses a branch joint for use with a Christmas tree to connect a plurality of additional branches to trunk of the Christmas tree, are designed to an umbrella-shaped body. A plurality of top and bottom ellipses respectively distributed on the top and bottom circumference of said body. A plurality of recesses form on a top edge of said body. Meanwhile, the additional branches are capable of being respectively inserted into said top ellipses, through the bottom ellipses, to be inward bent at a specific angle then for retaining a distal end of each branch within the corresponding recess whereby the branches and the umbrella-shaped body are retained together in a more natural, simple and useful manner. However, existing prior art fails to provide a structure or design that accommodates feline behavior or mitigates the risk of cats damaging tree decorations or the Christmas tree.

Therefore, there is a need for an artificial Christmas Tree that enables cats to engage in play without damaging the Christmas tree and addresses the challenges faced by the pet owners.

### SUMMARY

The present invention discloses a structure that enables an animal, for example, a cat to rest and play. The structure comprising at least one attachment assembly configured to be at least one of integrally and detachably fixed to the structure. At least one of the structure and the attachment assembly defines at least one pathway. At least one of the structure and the attachment assembly enables an animal to maneuver though the pathway and provides a resting space. In one embodiment, the attachment assembly comprises at least one of a platform and a decorative assembly. In one embodiment, the structure comprises at least one of an artificial Christmas tree, a natural tree and a tree shaped structure. In one embodiment, the Christmas tree comprises a trunk and a decorative assembly. The decorative assembly is at least one of detachably attached to the trunk and integrally attached to the trunk. The climbing structure is at least one of detachably attached to the trunk and integrally attached to the trunk. Further, the decorative assembly is configured to simulate at least one of the foliage, branches, and ornamental structures. The trunk is formed of at least one hollow member having at least one opening. The trunk further comprises an interior side and an exterior side. The trunk is dimensioned to allow at least one cat to move over at least one of the interior side and the exterior side of the trunk.

The trunk further comprises a climbing structure. The climbing structure defines a pathway extending along at least a portion of a length of the trunk. The pathway is dimensioned to allow at least one animal to move along or within the trunk. In one embodiment, the decorative assembly is dimensioned to allow the at least one animal to access the pathway. In one embodiment, the climbing structure comprises a pole disposed at the interior side of the trunk. The pole extends at least partially along a length of the trunk. In one embodiment, the pole is disposed at least one of detachably and integrally at the trunk. In one embodiment, the pole comprises at least one of a textured surface, protruded structures, recessed structures and a fabric layer. In another embodiment, the climbing structure comprises a textured surface formed on at least one of the interior side and exterior side of the trunk. The textured surface and fabric layer is configured to enable the cat to climb along the length of the trunk. In yet another embodiment, the climbing structure comprises at least one of protruded structures and recessed structures formed on at least one of the interior side and the exterior side of the trunk. At least one of the protruded structures and the recessed structure is configured to enable the cat to climb along the length of the trunk. In yet another embodiment, the climbing structure comprises at least one of fabric layer, poles, platforms, textured surface or any combination of arrangement thereof.

In yet another embodiment, the Christmas tree further comprises at least one platform disposed on the trunk. In one embodiment, the platform extends at least partially within the interior side of the trunk. In another embodiment, the Christmas tree further comprises at least one platform disposed on the interior side of the trunk. In yet another embodiment, the Christmas tree further comprises at least one platform disposed on the exterior side of the trunk. In yet another embodiment, the Christmas tree further comprises one or more of at least one platform disposed within the trunk, at least one platform disposed at an exterior side of the trunk, at least one platform disposed at least partially within the trunk, or any combination of arrangement thereof. In yet another embodiment, the platform comprises at least one of the opening and notches. In one embodiment, the platform is at least one of detachably attached to the trunk and integrally attached to the trunk.

In one embodiment, the trunk is formed of one or more hollow members. The hollow member having at least one opening. The Christmas tree further comprise at least one platform disposed adjacent to the opening. The platform is disposed on the exterior side of the hollow member and is configured to encircle over at least a portion of the hollow member. The platform is configured as a flat surface to support the cat. The Christmas tree further comprises one or more fastener members attached to at least one of the interior side and the exterior side of the hollow member. In one embodiment, at least one fastener member is at least one of detachably attached to the hollow member and integrally attached to the hollow member. In another embodiment, the decorative assembly is integrally or detachably attached to the artificial Christmas tree via the fastener member. In one embodiment, the fastener member comprises a plurality of apertures to receive and fasten the decoration assembly.

In yet another embodiment, the Christmas tree further comprises a base, the trunk is at least one of detachably and integrally disposed above the base and the pole extends at least one of detachably and integrally from the base within the trunk. The base extends to at least one of a periphery of the trunk and beyond the periphery of the trunk. In one embodiment, the bottom portion of the trunk is configured to function as a base and enables the artificial Christmas tree to maintain a vertical orientation.

The Christmas tree further comprises a connecting member disposed at a top portion of the trunk. The connecting member is configured to receive and position a corresponding connecting portion of the decorative assembly. In one embodiment, the connecting member is at least one detachably attached to the trunk and integrally attached to the trunk.

In yet another embodiment, the artificial Christmas tree comprises a base, the pole extends at least one of detachably and integrally from the base, and the trunk is at least one of detachably and integrally arranged to enclose the base and the pole. A circumference of the base is less than the periphery of the trunk. The trunk further comprises a rim extending transversely from a bottom portion of the trunk.

In yet another embodiment, the artificial Christmas tree comprises a base and at least one leg detachably or integrally disposed above the base. The trunk comprises an elongated hollow body having two opposing end portions and a panel detachably disposed on at least one end portion. In one embodiment, the panel is integrally disposed on at least one end portion. The trunk is detachably mounted above the leg such that panel rests on the leg and positions the trunk at an elevated height relative to a ground surface. In one embodiment, the trunk is integrally mounted above the leg.

In yet another embodiment, the artificial Christmas tree comprises the trunk including an elongated hollow body having two opposing end portions and at least one panel detachably or integrally disposed on at least one opposing end portion and is configured to at least partially close the opposing end portions.

In yet another embodiment, the artificial Christmas tree comprises one or more legs detachably or integrally extending from the panel towards the exterior side of the trunk. The legs are configured to support the trunk to stand in a vertical orientation. In yet another embodiment, the legs extend at least one of angularly and perpendicularly with respect to the panel. In yet another embodiment, at least one of the decorative assembly and the platform is at least one of detachably and integrally attached to a natural tree or an artificial tree.

In one embodiment, the artificial Christmas tree comprises a frame and a decorative assembly. At least one of the frame and the decorative assembly define a pathway. The pathway extends at least a portion of a length of the frame. The pathway is configured to enable a cat to move over or within the frame. The frame comprises a plurality of beam portions. The beam portion are interconnected to define an elongated tower having a progressively varying cross-section along a height of the frame. The plurality of beam portions is connected to form openings distributed along the height of the frame. The openings collectively permit the cat to climb along the tower. In one embodiment, the beam portions are interconnected to support one or more platforms to provide a space to support the cat. In one embodiment, the beam portions are at least one of detachably and integrally connected to one another, and the platform is at least one of detachably and integrally connected to the beam portions. The decorative assembly is attached at least one of integrally and detachably to the frame. The decorative assembly is configured to simulate at least one of foliage, branches, and ornamental structures.

In another embodiment, the frame comprises an elongated member and a plurality of platforms detachably or integrally arranged over the elongated member. The plurality of platforms is arranged spaced apart from one another and at least one platform comprises at least one opening connected to the pathway. The opening is dimensioned to allow passage of the cat. The elongated member comprises a plurality of sections detachably connectable to one another, such that one or more sections are selectively attachable and removable to adjust a height of the elongated member. In one embodiment, the plurality of sections is integrally connected to one another. In another embodiment, the platform comprises a body defining at least one of holes and notches.

In yet another embodiment, each of the plurality of platforms comprises a circular, flat structure. Each platform has a circumference different from a circumference of another platform. The plurality of platforms is arranged along the elongated member in an order of decreasing circumferences to form a tapered configuration. In yet another embodiment, at least one platform is detachably or integrally coupled to the tree via the fastener member. The platform extends beyond a structure of the Christmas tree.

In yet another embodiment, the frame comprises a base, a plurality of elongated members detachably or integrally extending from the base, and at least one platform supported by, coupled to, or disposed along the plurality of elongated members.

The artificial Christmas tree further comprises one or more fastener members coupled to at least one of the elongated members and the platforms. In one embodiment, the fastener members are detachably or integrally coupled to at least one of the elongated members and the platforms. In another embodiment, the fastener member is detachably or integrally coupled to the decorative assembly.

In one embodiment, an artificial Christmas tree comprises a trunk, optionally a base, and a decorative assembly. The trunk comprises a climbing structure. The climbing structure defines at least one pathway extending along at least a portion of a length of the trunk. The pathway enables the cat to move along or within the length of the trunk. The climbing structure comprises at least one of fabric layer, poles, platforms, textured surface or any combination of arrangement thereof. The climbing structure is detachably or integrally configured to the Christmas tree. The platforms comprise at least one of holes and notches. The trunk comprises an elongated hollow body having two opposing end portions and a panel detachably or integrally disposed on at least one end portion. The elongated hollow body is formed of at least one hollow member, and the panel comprises at least one of holes and notches.

The artificial Christmas tree optionally comprises a pole disposed at the interior side of the trunk. The pole extends at least partially along a length of the trunk. The pole is detachably or integrally disposed at the trunk. The pole comprises a plurality of pole sections detachably connectable to one another, such that one or more pole sections are selectively attachable and removable to adjust a height of the pole. In another embodiment, the poles sections are integrally connected to one another. Further, the pole detachably or integrally extends from the base. The decorative assembly is configured to simulate at least one of the foliage, branches, and ornamental structures. The decorative assembly is detachably or integrally attached to at least one of platform, hollow member, hollow body and pole. The foliage arranged to define an area to support a cat for resting and maneuvering.

### BRIEF DESCRIPTION OF THE DRAWINGS

FIG. 1 exemplarily illustrates a perspective view of an artificial Christmas tree integrated with a cat tower including a pole, according to an embodiment of the present invention.

FIG. 2 exemplarily illustrates a perspective view of an artificial Christmas tree integrated with a cat tower including a pole, according to another embodiment of the present invention.

FIG. 3 exemplarily illustrates a perspective view of an artificial Christmas tree integrated with a cat tower without a base, according to yet another embodiment of the present invention.

FIG. 4 exemplarily illustrates a perspective view of an artificial Christmas tree integrated with a cat tower with a base, according to yet another embodiment of the present invention.

FIG. 5 exemplarily illustrates a perspective view of an artificial Christmas tree integrated with a cat tower with a base extending beyond a circumference of a trunk, according to yet another embodiment of the present invention.

FIG. 6 exemplarily illustrates a perspective view of an artificial Christmas tree integrated with a cat tower with different types of platforms, according to yet another embodiment of the present invention.

FIG. 7 exemplarily illustrates the fastener members extending from the platform, according to an embodiment of the present invention.

FIG. 8 exemplarily illustrates a top portion of the trunk having the connecting member, according to an embodiment of the invention.

FIG. 9 exemplarily illustrates an interior side of the top portion of the trunk having a coupling member, according to an embodiment of the present invention.

FIG. 10 exemplarily illustrates a cross-section of the top portion of the trunk, according to an embodiment of the present invention.

FIG. 11 exemplarily illustrates a perspective view of an artificial Christmas tree formed of a frame comprising beam portions, according to an embodiment of the present invention.

FIG. 12A exemplarily illustrates a perspective view of an artificial Christmas tree integrated with a cat tower including a pole, according to yet another embodiment of the present invention.

FIG. 12B exemplarily illustrates a perspective view of an artificial Christmas tree integrated with a cat tower including a pole with vase shaped base, according to yet another embodiment of the present invention.

FIG. 13 exemplarily illustrates a perspective view of an artificial Christmas tree integrated with a cat tower including a pole extending along a partial length of the cat tower, according to yet another embodiment of the present invention.

FIG. 14 exemplarily illustrates a cross-sectional view of the artificial Christmas tree of FIG. 13.

FIG. 15 exemplarily illustrates a perspective view of an artificial Christmas tree integrated with a cat tower including a pole extending along the length of the cat tower, according to yet another embodiment of the present invention.

FIG. 16 exemplarily illustrates a cross-sectional view of the artificial Christmas tree of FIG. 15.

FIG. 17 exemplarily illustrates a perspective view of an artificial Christmas tree including a pole detachably disposed over the base and a hollow body positioned without connection to the base, according to yet another embodiment of the present invention.

FIG. 18 exemplarily illustrates a cross-sectional view of an artificial Christmas tree including a hollow body without a rim, according to yet another embodiment of the present invention.

FIG. 19 exemplarily illustrates a perspective view of an artificial Christmas tree integrated with a cat tower at an elevated height, according to yet another embodiment of the present invention.

FIG. 20 exemplarily illustrates a cross-sectional view of the artificial Christmas tree of FIG. 19.

FIG. 21 exemplarily illustrates a perspective view of an artificial Christmas tree integrated with a cat tower including angular legs, according to yet another embodiment of the present invention.

FIG. 22 exemplarily illustrates a cross-sectional view of the artificial Christmas tree of FIG. 21.

FIG. 23 exemplarily illustrates a perspective view of an artificial Christmas tree integrated with a cat tower including vertical legs attached to the base, according to yet another embodiment of the present invention.

FIG. 24 exemplarily illustrates a cross-sectional view of the artificial Christmas tree of FIG. 23.

FIG. 25 exemplarily illustrates a perspective view of an artificial Christmas tree integrated with a cat tower including a frame, one or more platforms and a plurality of pole sections defining a center pole, according to yet another embodiment of the present invention.

FIG. 26 exemplarily illustrates a perspective view of an artificial Christmas tree integrated with a cat tower including a frame and a plurality of pole sections defining a center pole, according to yet another embodiment of the present invention.

FIG. 27 exemplarily illustrates a perspective view of an artificial Christmas tree integrated with a cat tower including a pole connected to a base, and one or more platforms with holes, according to yet another embodiment of the present invention.

FIG. 28 exemplarily illustrates a perspective view of an artificial Christmas tree including a frame comprising a base, a plurality of elongated members extending from the base, and at least one platform supported by the plurality of elongated members, according to yet another embodiment of the present invention.

FIG. 29 exemplarily illustrates a perspective view of an artificial Christmas tree comprising platforms including at least one of holes and notches, according to yet another embodiment of the present invention.

FIG. 30 exemplarily illustrates a perspective view of an artificial Christmas tree comprising platforms extending beyond a structure of the tree, according to yet another embodiment of the present invention.

FIG. 31 exemplarily illustrates a perspective view of an artificial Christmas tree comprising foliage defining a platform, according to yet another embodiment of the present invention.

FIG. 32 exemplarily illustrates a perspective view of an artificial Christmas tree comprising platforms extending beyond a structure of the tree, according to yet another embodiment of the present invention.

### DETAILED DESCRIPTION OF EXAMPLE EMBODIMENTS

The present invention discloses a structure that enables an animal, for example, a cat to rest and play. The structure comprising at least one attachment assembly configured to be at least one of integrally and detachably fixed to the structure. At least one of the structure and the attachment assembly defines at least one pathway. At least one of the structure and the attachment assembly enables an animal to maneuver though the pathway and provides a resting space. In one embodiment, the attachment assembly comprises at least one of a platform and a decorative assembly. In one embodiment, the structure comprises at least one of an artificial Christmas tree, a natural tree and a tree shaped structure. In one embodiment, the Christmas tree comprises a trunk or a frame, and a decorative assembly. The decorative assembly is detachably attached to the trunk or the frame. Further, the decorative assembly is configured to simulate at least one of the foliage, branches, and ornamental structures.

### Definitions

Structure: The term “structure” refers to any natural, artificial, or hybrid object having a physical form capable of supporting or receiving one or more components. The structure may include or define one or more load-bearing, supporting, or mounting portions configured to receive attachment assemblies, platforms, decorative assemblies, or other components. The structure comprises a natural tree, an artificial Christmas tree, or a tree-shaped structure.

Trunk: The term “trunk” refers to an elongated portion of the structure. The trunk may be solid, hollow, segmented, modular, telescoping, or unitary, and may be formed from natural, artificial, or composite materials. The trunk may be integrally formed with or detachably coupled to other components of the structure, including branches, frames, attachment assemblies, or platforms, and may define or support one or more pathways or attachment points.

Frame: The term “frame” refers to one or more components of any shape, size, or configuration that, individually or collectively, define and form at least a portion of the structure. The frame may be continuous or discontinuous and may be formed from a single unitary component or from a plurality of components coupled together. The frame may further include one or more attachment points configured to receive, support, or couple to decorative assemblies and platforms. In some embodiments, a platform forms part of the frame itself, while in other embodiments the platform is a separate component attached to the frame. The frame may provide structural support, define shape or geometry, and cooperate with other components to define one or more pathways or resting spaces for an animal.

Platform: The term “platform” refers to any surface, member, or structure configured to support at least a portion of an animal's body during movement or rest. The platform may be fixed, movable, foldable, collapsible, adjustable, or selectively positionable along the structure. The platform may be of any shape, size, thickness, or geometry.

Decorative assembly: The term “decorative assembly” refers to any ornamental, or aesthetic component configured to be integrally formed with or detachably attached to the structure, attachment assembly, or platform. The decorative assembly also performs a functional role, including concealing structural components, providing grip, cushioning, or serving as part of a pathway or resting space.

Attachment assembly: The term “attachment assembly” refers to any component, sub-assembly, or combination of components configured to be integrally formed with or detachably coupled to a structure. The attachment assembly may include, but is not limited to, one or more platforms and decorative assembly.

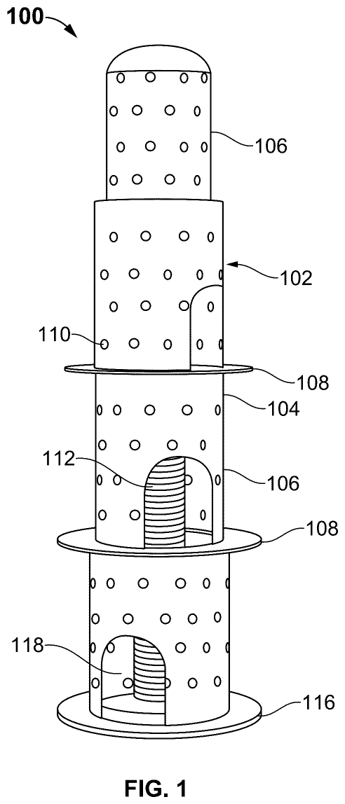

Referring to FIG. 1 to FIG. 6, an artificial Christmas tree (100, 200, 300, 400, 500, 600) is integrated with a tower for animals to climb, play and rest. In an example, the animal includes cat. In an embodiment, the tower includes a cat tower 102 designed for cats. The cat tower 102 comprises a trunk 104. The trunk 104 comprises an interior side and an exterior side. In one embodiment, the trunk 104 comprises at least one hollow member 106. The hollow member 106 comprises at least one opening 118. The opening 118 is configured to process access to the interior side of the trunk 104. In one embodiment, the hollow member 106 is configured as a stackable and modular structure, such that individual hollow members 106 could be used independently or selectively stacked together to form a combined structure. In another embodiment, the hollow member 106 is configured as a non-modular assembly that is provided in a pre-assembled state or assembled by the user.

The trunk 104 is formed by the hollow member 106, and therefore any reference to the interior side or the exterior side of the trunk 104 is to be understood as a reference to a corresponding interior side or exterior side of the hollow member 106. The trunk 104 comprises a climbing structure. The climbing structure defines a pathway extending along a length of the trunk 104. The pathway is connected to the opening 118. The pathway enables the cat to move along the length of the trunk 104. The climbing structure could be extendable or positioned at various locations along or within the hollow member 106 to facilitate cat movement. The climbing structure could be freestanding, coupled to interior side of the hollow member 106, or provided in any combination thereof. In another embodiments, the interior side of the hollow member 106 might be formed of a material or surface treatment configured to permit climbing or traversal by the cat without the inclusion of additional climbing structure.

The artificial Christmas tree (100, 200, 300, 400, 500, 600) further comprises a decorative assembly detachably attached to the trunk 104. The decorative assembly is configured to simulate at least one of the foliage, branches, and ornamental structures.

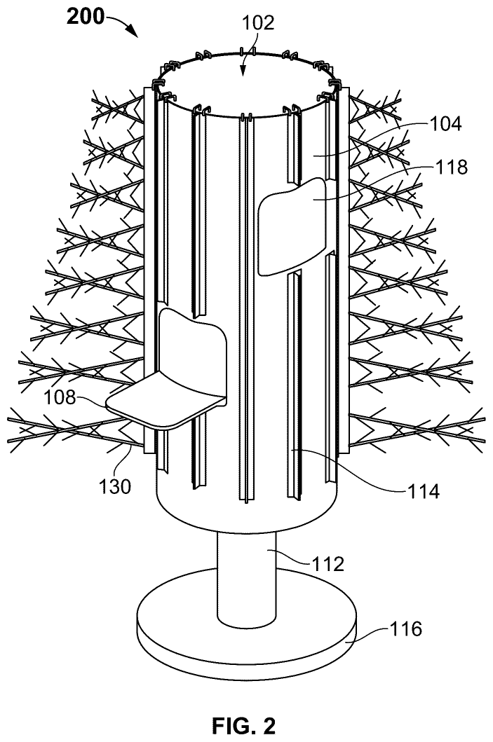

Referring to FIG. 1 and FIG. 2, the climbing structure comprises a pole 112 disposed at the interior side of the trunk 104. The pole 112 extends at least partially along the length of the trunk 104. The pole 112 enables the cat or an animal to climb over the cat tower 102. In one embodiment, the pole 112 comprises a textured surface. The textured surface is configured to allow the cat to scratch nails and to facilitate climbing upstairs using a rope-wrapped portion. In another embodiment, the pole 112 comprises protruded structures. In yet another embodiment, the pole 112 comprises recessed structures. The textured surface, protruded structures and the recessed structures are configured to enable to aid the cat to move on the cat tower 102. The pole 112 might extend along a central portion of the trunk 104 to allow the cat to climb, or alternatively, the internal material might be configured to allow the cat to climb along the trunk 104.

The artificial Christmas tree 100 comprises one or more hollow members 106 configured to form the trunk 104. Each hollow member 106 comprises at least one opening 118. The artificial Christmas tree 100 is also referred to as the tree 100 throughout this document. In various embodiments, the artificial Christmas tree 100 may be configured to be stackable.

Optionally, the Christmas tree (100, 200) comprises at least one platform 108. In one embodiment, the platform 108 is disposed adjacent to the opening 118. In one embodiment, the platform 108 is disposed at the exterior side of the trunk 104. The platform 108 is configured to encircle over at least a portion of the hollow member 106. In one embodiment, the platform 108 is configured as a flat surface to support a cat. In another embodiment, the platform 108 is configured to be detachable or retrofittable, allowing flexibility in installation, customization, or maintenance. In one embodiment, the platform 108 could be permanently attached adjacent to the opening 118 or provided in a pre-assembled configuration. The platform 108 is configured to allow the cat to climb, rest, or move within the hollow member 106.

Referring to FIG. 1, a plurality of apertures 110 is formed on the trunk 104 to receive and fasten the decoration assembly. Referring to FIG. 1 and FIG. 2, the Christmas tree (100, 200) comprises one or more fastener members 114 attached to at least one of the interior side and the exterior side of the hollow member 106. The fastener member 114 is configured to detachably attach the decorative assembly. Referring to FIG. 1, the plurality of apertures 110 are configured to function as the fastener member 114. The trunk 104 further comprises a connector member 130. The connector member 130 comprises a branch like configuration, which is configured to receive the decorative assembly. The connector member 130 is configured to detachably fasten to the fastener member 114.

Referring to FIG. 1 to FIG. 6, in one embodiment, a bottom portion of the trunk 104 is configured to function as a base 116 and enables the artificial Christmas tree (100, 200, 300, 400, 500, 600) to be in a vertical orientation. Referring to FIG. 1 and FIG. 2, in yet another embodiment, the artificial Christmas tree (100, 200) comprises a base 116 and the trunk 104 is disposed above the base 116. The pole 112 extends from the base 116, and the trunk 104 is coupled to the pole 112. Referring to FIG. 1, the pole 112 is entirely enclosed by the trunk 104. Referring to FIG. 2, the trunk 104 is arranged over the pole 112 such that at least the bottom portion of the pole 112 is exposed and at least the portion of upper portion of the pole 112 is enclosed by the trunk 104. The pole 112 is detachably attached to the trunk 104 of the Christmas tree 200.

Referring to FIG. 1 to FIG. 6, in another embodiment, the platform 108 is disposed at least partially within the trunk 104. In yet another embodiment, the platform 108 is disposed at the trunk 104 in such a way that at least a portion of the platform 108 is positioned within the trunk 104 and at least a portion of the platform 108 extends to an exterior side of the trunk 104. In yet another embodiment, the platform 108 is disposed at the interior side of the trunk 104.

In yet another embodiment, the trunk 104 comprises at least one platform 108 disposed within the trunk 104, at least one platform 108 disposed at an exterior side of the trunk 104, at least one platform 108 disposed at least partially within the trunk 104, and any combination of arrangement thereof.

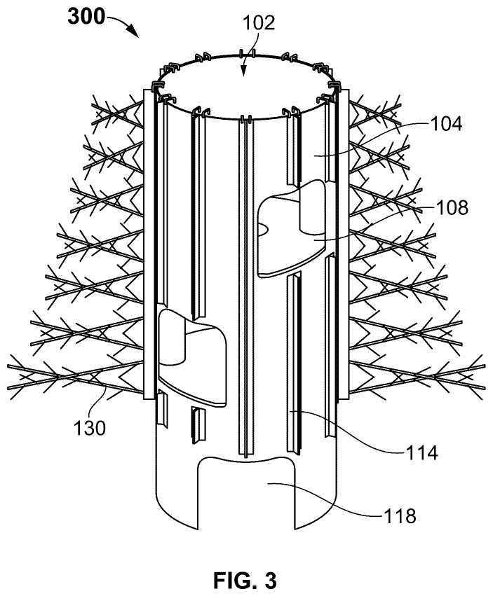

Referring to FIG. 3, the Christmas tree 300 comprises the cat tower 102 comprising the trunk 104. The trunk 104 comprises at least one hollow member 106 and one or more platforms 108. The hollow member 106 comprises at least one opening 118. The platforms 108 are arranged within the trunk 104 adjacent to the opening 118. The fastener member 114 is configured to detachably attach the decorative assembly. Further, the bottom portion of the trunk 104 is configured to function as the base 116 and enables the artificial Christmas tree 300 to be in a vertical orientation.

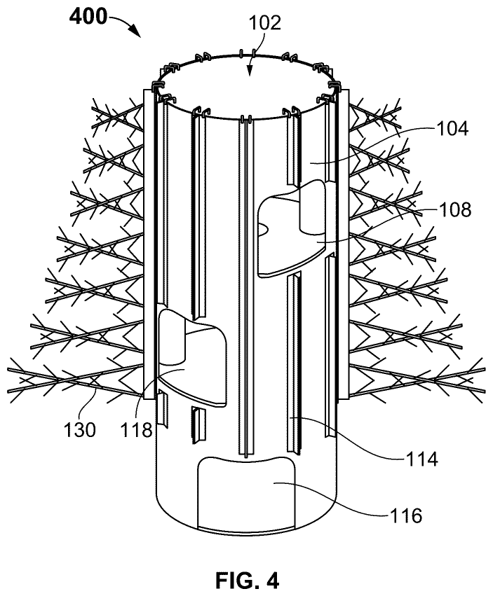

Referring to FIG. 4, the Christmas tree 400 further comprises the base 116 and the trunk 104 is disposed above the base 116. The base 116 extends to at least a periphery of the trunk 104. The trunk 104 comprises at least one hollow member 106 and one or more platforms 108. The hollow member 106 comprises at least one opening 118. The platforms 108 are arrange within the trunk 104 adjacent to the opening 118. The fastener member 114 is configured to detachably attach the decorative assembly.

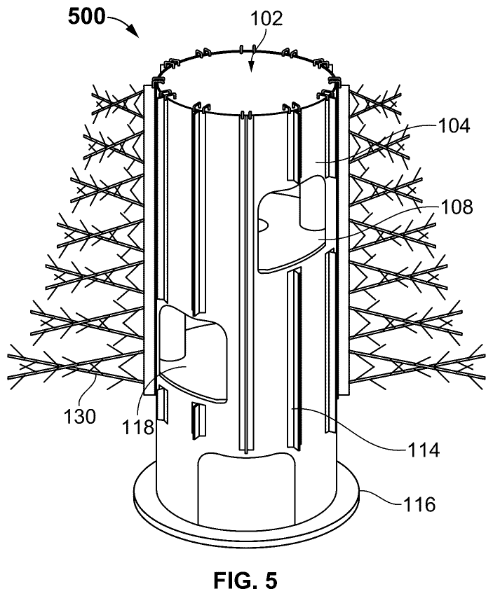

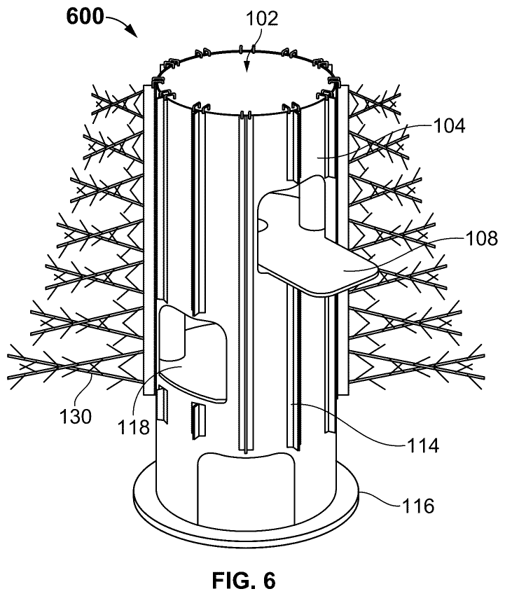

Referring to FIG. 5 and FIG. 6, the Christmas tree (500, 600) further comprises the base 116 configured to extend beyond the periphery of the trunk 104. The trunk 104 comprises at least one hollow member 106 and one or more platforms 108. The hollow member 106 comprises at least one opening 118. The fastener member 114 is configured to detachably attach the decorative assembly. Referring to FIG. 5, the platform 108 is disposed on the interior side of the hollow member 106. Referring to FIG. 6, at least one the platform 108 is arranged within the trunk 104 adjacent to the opening 118, and at least one platform 108 arranged in such a way at least a portion of the platform 108 is within the trunk and at least a portion of the platform 108 extends beyond the trunk 104.

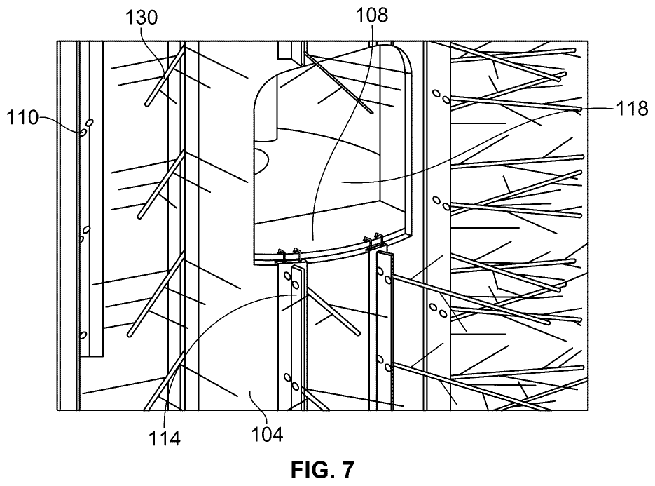

Referring to FIG. 7, the fastener member 114 is arranged on the trunk 104 such that a decorative assembly, for example branches, could hang from the platform 108 or from the hollow member 106. In one embodiment, a cat pillow may be placed inside the hollow member 106 of the trunk 104 to provide a resting area for a cat.

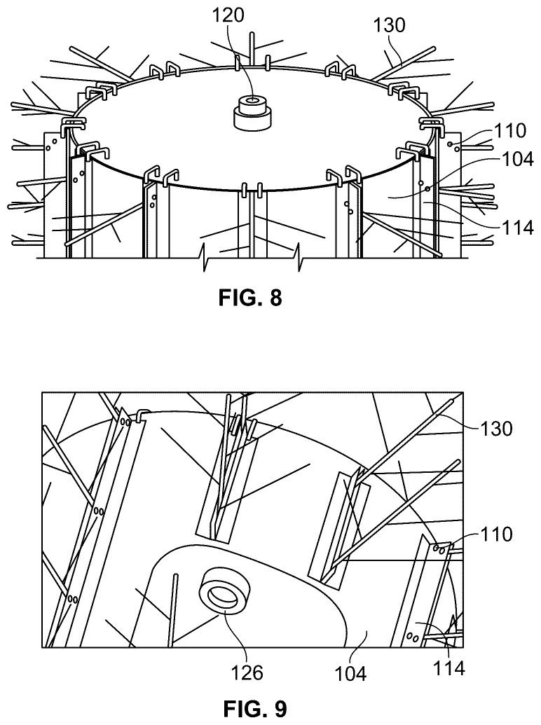

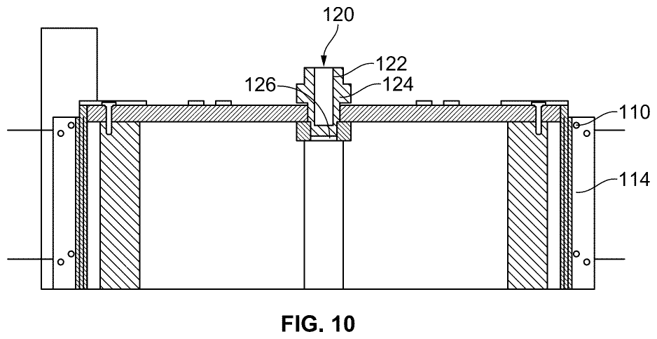

Referring to FIG. 8 to FIG. 10, the trunk 104 comprises an upper portion. In one embodiment, the upper portion is a flat surface. The upper portion of the trunk 104 could be of any other suitable shape to receive the decorative assembly. Alternatively, the upper portion of the trunk 104 could be of any other suitable shape to provide a resting surface for a cat. The upper portion comprises a connecting member 120. The connecting member 120 is configured to receive and position a corresponding connecting portion of the decorative assembly. The connecting member 120 comprises a tubular member 122 having a first end portion and a second end portion opposite to the first end portion. The first end portion lies above the top portion of the trunk 104, and the second end portion lies within the trunk 104.

Further, the trunk 104 comprises flanges 124 at the first end portion to secure the connecting member 120 in place. The connecting member 120 further comprises a coupling member 126 disposed at the interior side of the trunk 104. The coupling member 126 is configured to retain the connecting member 120 in position. The connecting member 120 could be fixed or integrally positioned, or alternatively configured to be detachable.

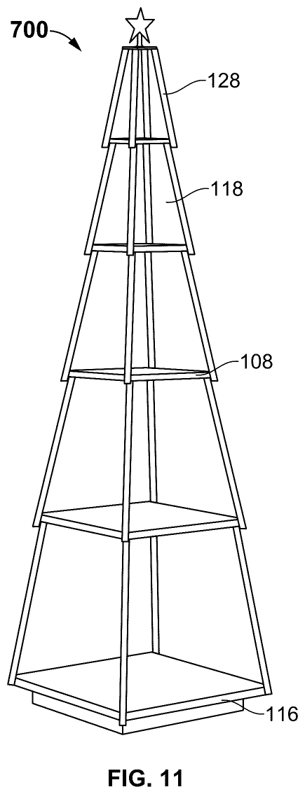

Referring to FIG. 11, an artificial Christmas tree 700 comprises a frame and a decorative assembly detachably attached to the frame. The decorative assembly is configured to simulate at least one of foliage, branches, and ornamental structures. The frame and the decorative assembly define a pathway extending along a length of the frame. The pathway is configured to enable a cat to move over the frame.

In one embodiment, the frame comprises a plurality of beam portions 128. The beam portion 128 are interconnected to define an elongated tower having a progressively varying cross-section along a height of the frame. The plurality of beam portions 128 is connected to form openings 118 distributed along the height of the frame. The openings 118 collectively permit the cat to climb along the tower. The beam portions 128 are interconnected to support one or more platforms 108 to provide a space to support the cat.

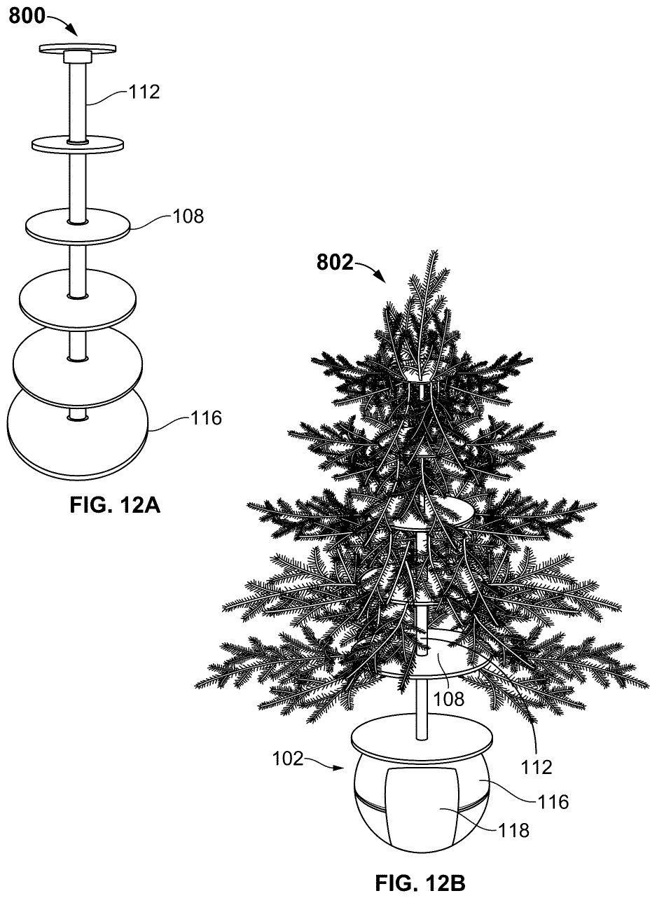

Referring to FIG. 12A, an artificial Christmas tree 800 comprises a base 116 and a pole 112 extending from the base 116. The artificial Christmas tree 800 further comprises one or more platforms 108 affixed to the pole 112. In one embodiment, the platforms 108 are arranged to be spaced apart from one another along the pole 112. In another embodiment, the platforms 108 comprise a circular configuration encircling the pole 112. Alternatively, the platforms 108 could have any other suitable shape or configuration. Referring to FIG. 12B, the artificial Christmas tree 802 integrated with the cat tower 102 including the pole 112 with vase shaped base 116, is illustrated. In various embodiments, the base 116 could be of any shape or configuration, but not limited to, vase shaped base 116 alone. The base 116 is a hollow body having the opening 118.

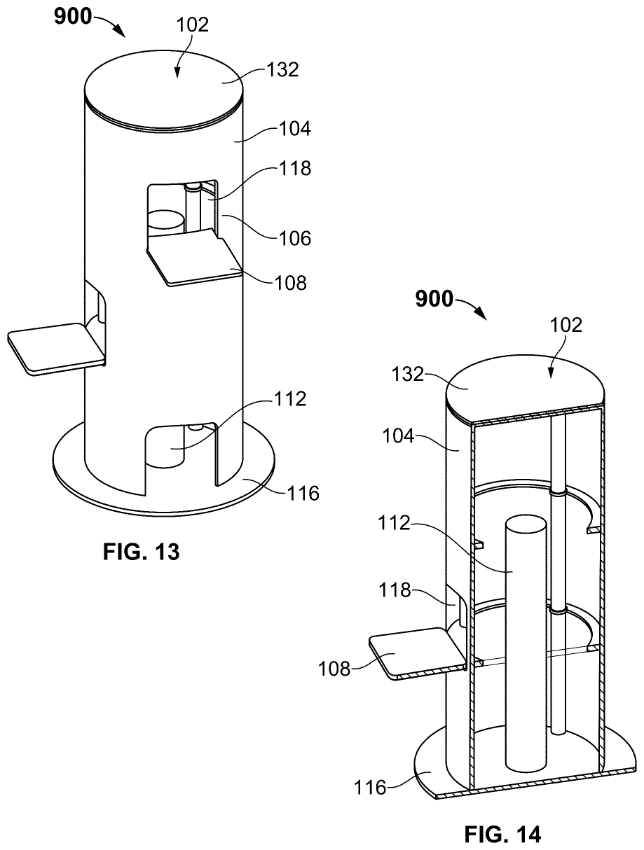

Referring to FIG. 13 to FIG. 18, an artificial Christmas tree (900, 1000, 1100, 1200) comprises the cat tower 102 comprising the trunk 104 and the climbing structure. The climbing structure defines at least one pathway extending along at least a portion of a length of the trunk 104. The trunk 104 is formed of at least one hollow member 106 having at least one opening 118 connected to the pathway. The trunk 104 comprises an interior side and an exterior side. The pathway is defined on at least one of the interior side and the exterior side of the trunk 104. The trunk 104 is dimensioned to allow at least one cat to move over at least one of the interior side and the exterior side of the trunk 104 via the pathway.

Referring to FIG. 13 to FIG. 16, the trunk 104 is detachably connected to the base 116. In one embodiment, the trunk 104 is integrally connected to the base 116. The artificial Christmas tree (900, 1000) further comprises the pole 112 connected to the base 116. The pole 112 is positioned at the interior side of the trunk 104. The base 116 extends beyond the periphery of the trunk 104. The pole 112 defines at least one pathway for the cat to move along a portion of a length of the trunk 104. The trunk 104 comprises an elongated hollow body having two opposing end portions and at least one panel 132 detachably disposed on at least one opposing end portion and is configured to at least partially close the opposing end portions. The hollow body is formed of at least one hollow member 106 having one or more openings 118 connected to the pathway. In one embodiment, the trunk 104 of the cat tower 102 is arranged free floating on the base 116.

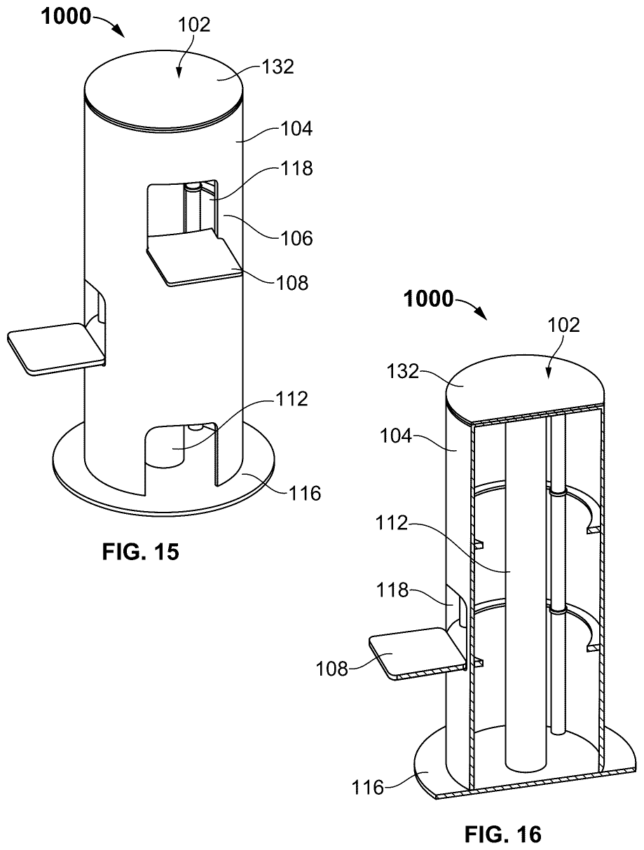

Referring to FIG. 13 and FIG. 14, in one embodiment herein, the pole 112 extends along a partial length of the trunk 104 from the base 116. Referring to FIG. 15 and FIG. 16, in one embodiment herein, the pole 112 extends along an entire length of the trunk 104 from the base 116.

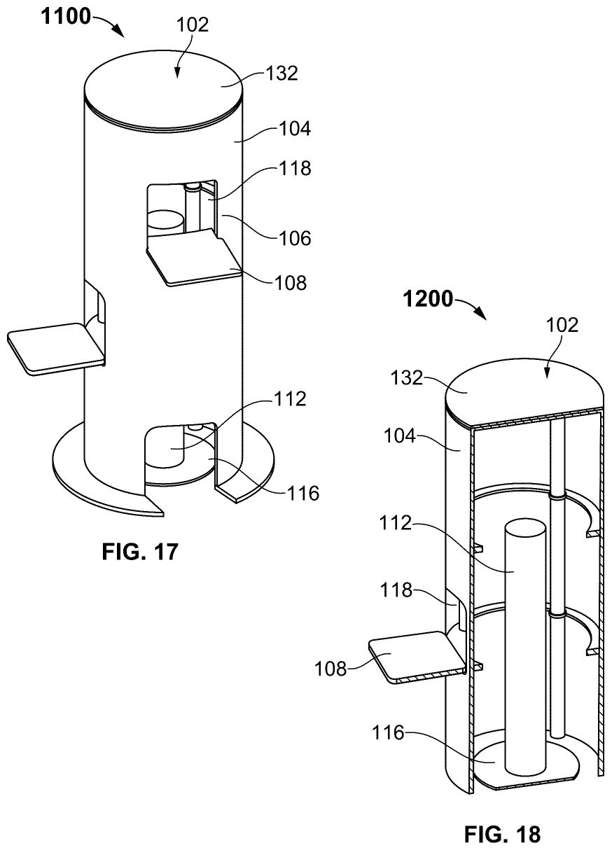

Referring to FIG. 17 and FIG. 18, in one embodiment, the hollow member 106 is not attached with the base 116. The pole 112 is connected to the base 116. The base 116 is arranged within the hollow member 106. The circumference of the base 116 is less than the periphery of the trunk 104. Referring to FIG. 17, the trunk 104 comprises a rim 140 extending transversely from a bottom portion of the trunk 104. The trunk 104 having the rim 140 is arranged to enclose the base 116 and the pole 112. Referring to FIG. 18, the hollow member 106 or the trunk 104 without the rim 140 is arranged over the pole 112.

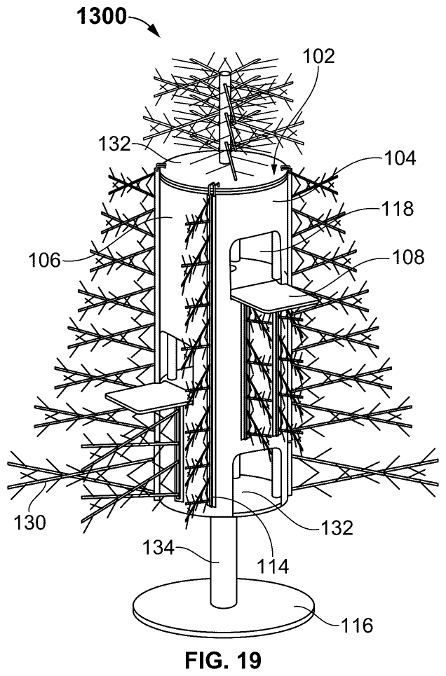

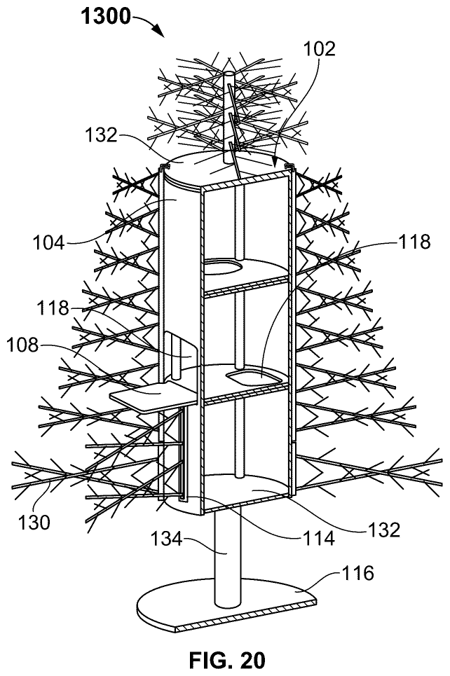

Referring to FIG. 19 and FIG. 20, in one embodiment, an artificial Christmas tree 1300 comprises the cat tower 102. Further, the cat tower 102 comprises the trunk 104 and the climbing structure. The climbing structure defines at least one pathway extending along at least a portion of a length of the trunk 104. The pathway enables the cat to move along the length of the trunk 104. The trunk 104 is formed of at least one hollow member 106 having at least one opening 118 connected to the pathway. The pathway is defined on at least one of the interior side and the exterior side of the trunk 104.

The artificial Christmas tree 1300 further comprises the base 116 and at least one leg 134 detachably disposed above the base 116. The trunk 104 comprises an elongated hollow member 106 having two opposing end portions. At least one end portion is a closed end portion, and the trunk 104 is detachably mounted above the leg 134 such that the closed end portion rests above the leg 134. In another embodiment, both opposing end portions are a closed end portion. The artificial Christmas tree 1300 further comprises the decorative assembly detachably attached to the trunk 104 via one or more fastener members 114. The decorative assembly is configured to simulate at least one of the foliage, branches, and ornamental structures. The fastener members 114 are detachably disposed at the closed end portion and the exterior side of the trunk 104.

In an embodiment, the artificial Christmas tree 1300 is pre-assembled or configured for assembly by a user. The artificial Christmas tree 1300 comprises the trunk 104 which is elevated relative to the base 116. The artificial Christmas tree 1300 further allows selective disconnection of the leg 134, thereby enabling to reduce or increase the height of the cat tower 102.

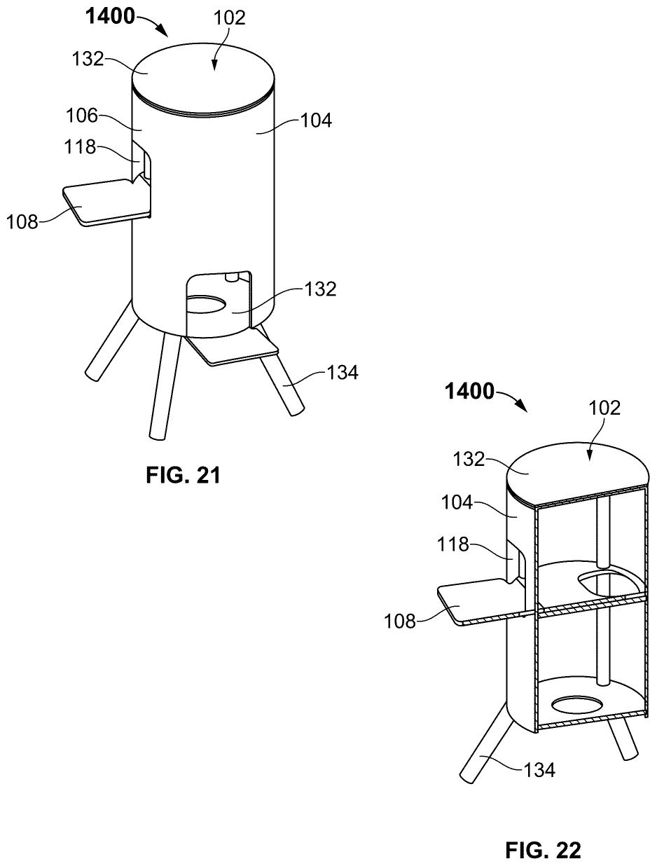

Referring to FIG. 21 to FIG. 24, in one embodiment, an artificial Christmas tree (1400, 1500) comprises the cat tower 102. Further, the cat tower 102 comprises the trunk 104 and the climbing structure. The climbing structure defines at least one pathway extending along at least a portion of a length of the trunk 104. The pathway is defined on at least one of the interior side and the exterior side of the trunk 104. The pathway enables the cat to move along the length of the trunk 104. The trunk 104 comprises an elongated hollow body having two opposing end portions and at least one panel 132. The panel 132 is detachably disposed on at least one opposing end portion and is configured to at least partially close the opposing end portions. In one embodiment, the panel 132 comprises one or more openings 118. In another embodiment, the panel 132 is formed as continuous structure without any opening to enclose the end portion of the elongated hollow member 106. The hollow body is formed of at least one hollow member 106 having at least one opening 118 connected to the pathway. The trunk 104 is dimensioned to allow at least one cat to move over at least one of the interior side and the exterior side of the trunk 104 via the defined pathway.

Referring to FIG. 21 to FIG. 24, the artificial Christmas tree (1400, 1500) further comprises a plurality of legs 134. The legs 134 extend from the panel 132 disposed at a bottom portion of the trunk 104 and towards the exterior side of the trunk 104. The legs 134 are configured to support the trunk 104 to stand in a vertical orientation. The artificial Christmas tree (1400, 1500) further allows selective disconnection of the leg 134, thereby enabling to reduce or increase the height of the cat tower 102. Referring to FIG. 21 and FIG. 22, the legs 134 extend angularly from the panel 132.

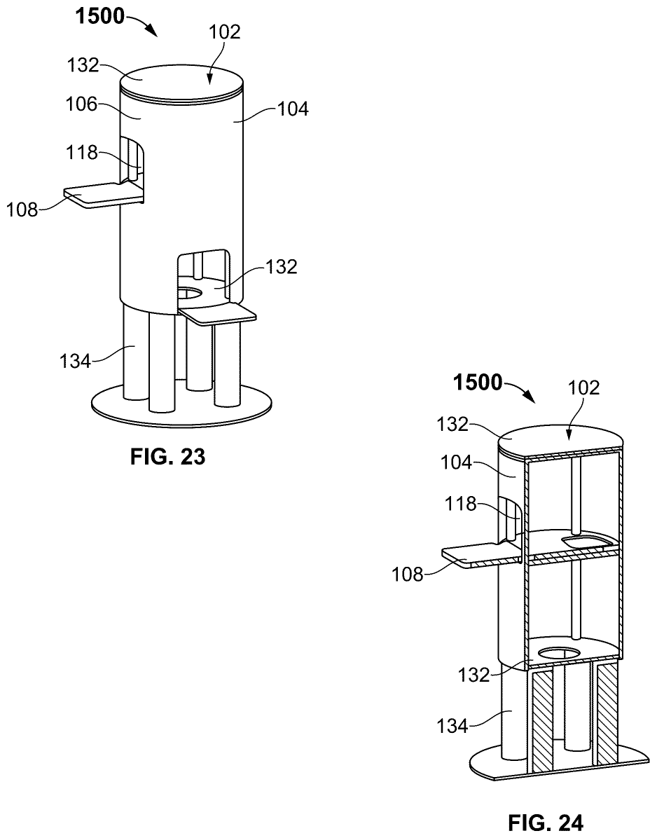

Referring to FIG. 23 and FIG. 24, the plurality of legs 134 extending between the bottom panel 132 of the trunk 104 and the base 116. In one embodiment, the legs 134 are oriented vertically relative to the base 116.

Referring to FIG. 14 to FIG. 24, the artificial Christmas tree (900, 1000, 1100, 1200, 1300, 1400, 1500) further comprises one or more of at least one platform 108 disposed within the trunk 104, at least one platform 108 disposed at an exterior side of the trunk 104, at least one platform 108 disposed at least partially within the trunk 104, or any combination of arrangement thereof. In one embodiment, the platforms 108 are arranged adjacent to the one or more openings 118 of the hollow member 106. In another embodiment, the platforms 108 are detachably mounted to any portion of the cat tower 102. In one embodiment, the platforms 108 are configured as a flat surface to support a cat.

In an embodiment, the platform 108 is configured to be detachable or retrofittable, allowing flexibility in installation, customization, or maintenance. Further, the platforms 108 could be permanently attached adjacent to the openings 118. The platform 108 is configured to allow the cat to climb, rest, or move along the trunk 104.

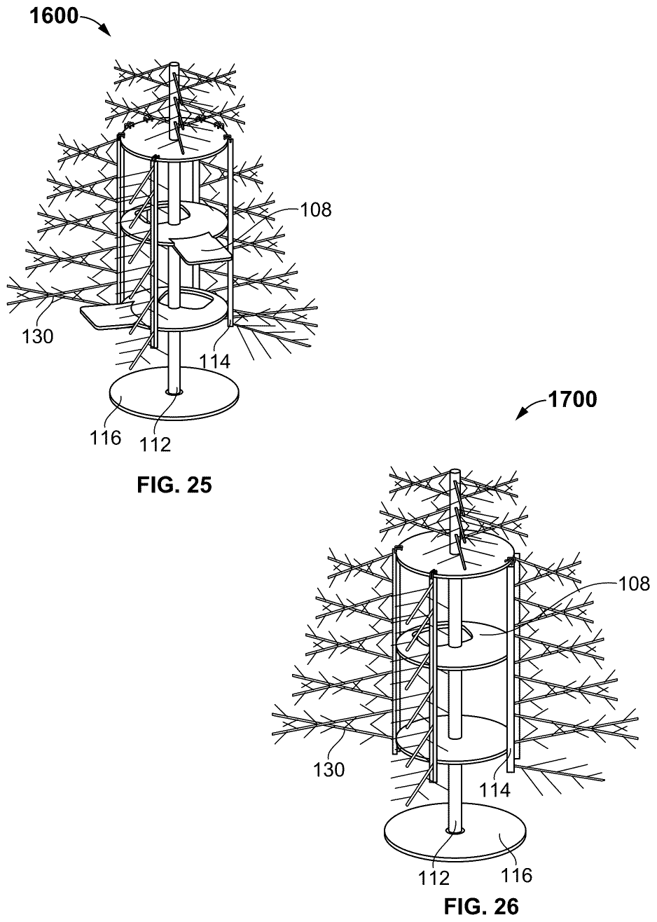

Referring to FIG. 25 to FIG. 30, in one embodiment, the artificial Christmas tree (1600, 1700, 1800, 1900, 2000, 2100) comprises a frame, and a decorative assembly detachably attached to the frame. The decorative assembly is configured to simulate at least one of foliage, branches, and ornamental structures. Further, at least one of the frame and the decorative assembly defines a pathway to enable an animal to move over the frame. The pathway extends at least a portion of a length of the frame.

The frame comprises an elongated member and a plurality of platforms 108 detachably arranged over the elongated member. In an example, the elongated member is a pole 112. The plurality of platforms 108 is arranged spaced apart from one another. At least one platform 108 comprises at least one opening 118 connected to the pathway, and the opening 118 is dimensioned to allow passage of the cat. In one embodiment, the elongated member comprises a plurality of sections detachably connectable to one another, such that one or more sections are selectively attachable and removable to adjust a height of the elongated member.

The artificial Christmas tree (1600, 1700, 1800, 1900, 2000, 2100) further comprises one or more fastener members 114 coupled to at least one of the elongated members and the platforms 108. The fastener member is configured to detachably couple the decorative assembly.

The platform 108 comprises a body defining at least one of holes 118 and notches 136. In one embodiment, the platform 108 is a circulate plate. Referring to FIG. 25, FIG. 26 and FIG. 28, the fastener member 114 is detachably coupled to one or more platforms 108. Referring to FIG. 25 and FIG. 26, the fastener member 114 is detachably coupled to at least three platforms 108. Further, at least one platform 108 comprises opening 118.

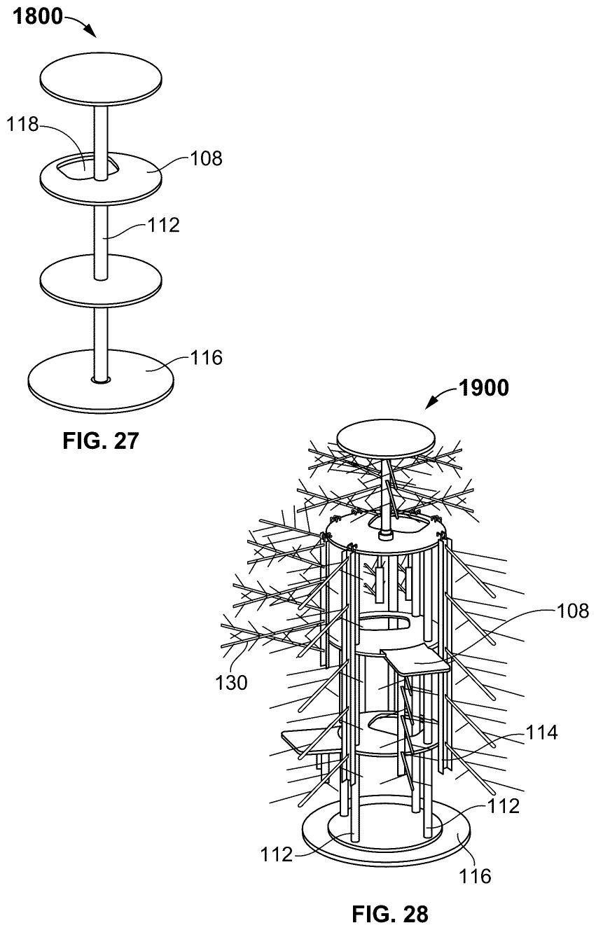

Referring to FIG. 27, in one embodiment, the platforms 108 comprise a circular configuration encircling the pole 112. Alternatively, the platforms 108 could have any other suitable configuration. At least one platform 108 of the one or more platforms 108 has an opening 118 connected to the pathway.

Referring to FIG. 28, in one embodiment the artificial Christmas tree 1900 comprises a plurality of poles 112 extending from the base 116 and one or more platforms 108 disposed across the pole sections. The poles 112 are arranged circumferentially and are configured to extend through, across, or adjacent to a plurality of vertically spaced platforms 108. The artificial Christmas tree 1900 further allows selective connection and disconnection of any component of the tree 1900, in order to increase or reduce the height of the cat tower 102. Further, the artificial Christmas tree 1900 comprises at least one platform 108 positioned at top portion of the tree 1900 is coupled with the tree 1900 by a fastener member 114.

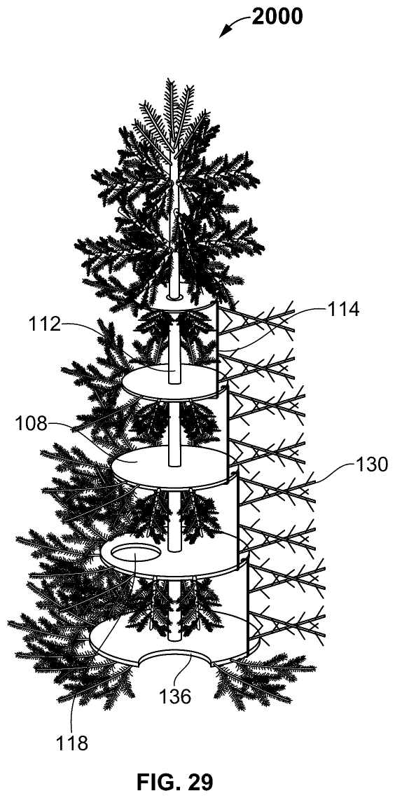

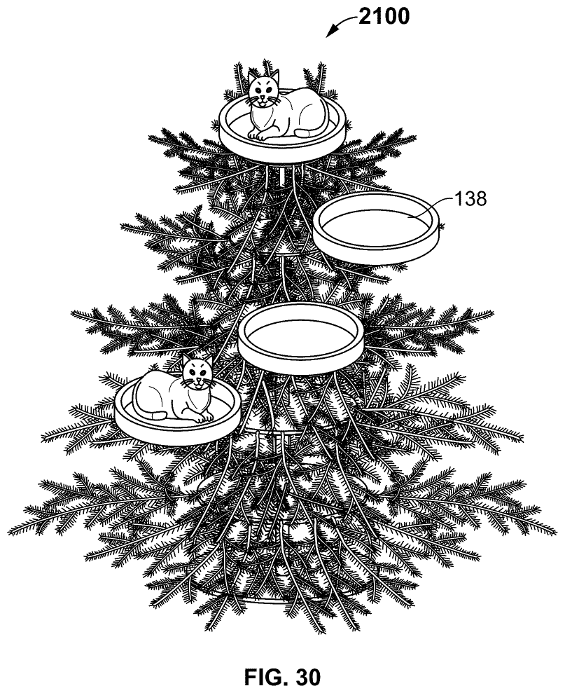

Referring to FIG. 29, the platforms 108 comprises a circular, flat structure. Each platform 108 has a circumference different from a circumference of another platform 108. The plurality of platforms 108 is arranged along the elongated member in an order of decreasing circumferences to form a tapered configuration. At least one platform 108 comprises at least one of holes 118 and notches 136. Referring to FIG. 30, at least one platform 108 is detachably coupled to the tree 2100 via the fastener member 114. The platform 108 is configured to extend beyond a structure of the artificial Christmas tree 2100. The platform 108 comprises a support body 138 having a base portion and a rim extending upwardly from the periphery of the base portion. The rim defines a recessed interior region sized to receive and support the body of the cat. In one embodiment, the support body 138 has a substantially circular planform, although other shapes, including oval, polygonal, or irregular configurations, may be employed without departing from the scope of the invention. The support body 138 is configured to be supported by, suspended from, or mounted to one or more structural members of the artificial Christmas tree 2100, such as branch members, elongated poles 112, support arms, or combinations thereof.

Referring to FIG. 13 to FIG. 30, the pole 112 comprises a plurality of pole sections detachably connectable to one another, such that one or more pole sections are selectively attachable and removable to adjust a height of the pole 112. The pole 112 comprises at least one of a textured surface, protruded structures, and recessed structures and a fabric layer. The climbing structure comprises at least one of fabric layer, poles 112, platforms 108, textured surface or any combination of arrangement thereof.

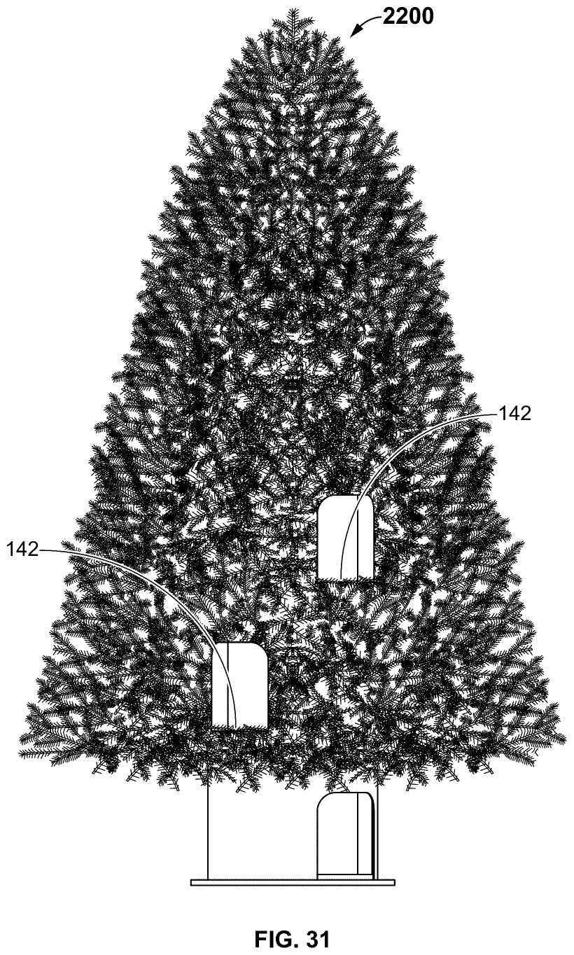

Referring to FIG. 25 to FIG. 30, in an embodiment herein, the artificial Christmas tree (1600, 1700, 1800, 1900, 2000, 2100) further allows selective connection and disconnection of any component of the tree (1600, 1700, 1800, 1900, 2000, 2100), in order to increase or reduce the height of the cat tower 102. Further, in one embodiment, the platform 108 of the plurality of platforms 108 is formed as continuous structure without any opening connected to the pathway. Referring to FIG. 31, the artificial Christmas tree 2200 could include any combination of the configurations described in FIG. 1 to FIG. 30, and further comprises foliage arranged to define an area or platform, represented by reference numeral 142, configured to support a cat for resting and maneuvering.

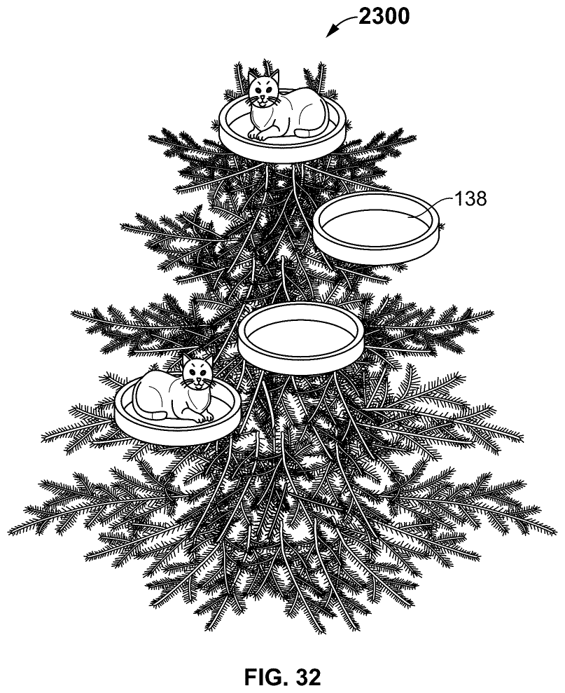

Referring to FIG. 32, the artificial Christmas tree 2300 comprises a frame and a decorative assembly attached to the frame. At least one of the frame and the decorative assembly defines a pathway. The pathway extends at least a portion of a length of the frame. The pathway is configured to enable an animal to move over or within the frame. The decorative assembly is attached to at least one of integrally and detachably to the frame. At least one platform 108 is detachably coupled to the artificial Christmas tree 2300. The platform 108 is configured to extend beyond a structure of the artificial Christmas tree 2300. The platform 108 comprises the support body 138 having a base portion and a rim extending upwardly from the periphery of the base portion. The rim defines a recessed interior region sized to receive and support the body of the cat. The artificial Christmas tree 2300 could include any combination of the configurations described in FIG. 1 to FIG. 31. In one embodiment, the support body 138, the platform 108 or the decorative assembly is designed for detachable attachment or integral attachment to a natural Christmas tree, a natural tree or an artificial tree.

The components of the artificial Christmas tree (100, 200, 300, 400, 500, 600, 700, 800, 802, 900, 1000, 1200, 1300, 1400, 1500, 1600, 1700, 1800, 1900, 2000, 2100, 2200, 2300), including but not limited to the trunk 104, hollow members 106, platforms 108, climbing structure, decorative assembly, fastener members 114, connecting members 120, pole 112, pole sections, frame, elongated members, beam portions 128, panels 132, base 116, legs 134, textured surfaces, fabric layers, protruded structures, recessed structures, and attachment assemblies, may be configured to be at least one of integrally formed with or detachably connected to corresponding components as described with reference to FIG. 1 to FIG. 32.

All configurations described herein may be manufactured with or without openings 118 or notches 136 formed in the platforms 108 or trunk 104. Any component of the artificial Christmas tree (100, 200, 300, 400, 500, 600, 700, 800, 802, 900, 1000, 1200, 1300, 1400, 1500, 1600, 1700, 1800, 1900, 2000, 2100, 2200, 2300) may be integrally formed with the artificial Christmas tree (100, 200, 300, 400, 500, 600, 700, 800, 802, 900, 1000, 1200, 1300, 1400, 1500, 1600, 1700, 1800, 1900, 2000, 2100, 2200, 2300) or detachably connected thereto. Any pathway may extend to the base 116 or terminate above the base 116. A top platform 108 may optionally include an opening 118. One or more hollow members 106 may be provided at any section of the structure, or the structure may be partially or fully open, with a hollow member 106 or internal space being defined upon application of branches or foliage. The structure may be modular to permit adjustment of height by addition or removal of sections. Any component may be preassembled or detachably attachable and removable, including foliage. Any type of foliage connection mechanism may be employed. The foliage may be coupled to platforms 108, hollow members 106, supporting structures, or poles 112.

The Artificial Christmas tree (100, 200, 300, 400, 500, 600, 700, 800, 802, 900, 1000, 1200, 1300, 1400, 1500, 1600, 1700, 1800, 1900, 2000, 2100, 2200, 2300) provides consumers an option for a holiday decoration that is reusable, with seasonal storage, and prevents the mess and hassle associated with a natural tree. Further, the cat tower 102 integrated with the tree (100, 200, 300, 400, 500, 600, 700, 800, 802, 900, 1000, 1200, 1300, 1400, 1500, 1600, 1700, 1800, 1900, 2000, 2100, 2200, 2300) provides a structure where cats could play and rest in, providing pet owners relief from damage to upholstery, furniture, curtains, etc. In certain embodiments, the artificial Christmas Tree (100, 200, 300, 400, 500, 600, 700, 800, 802, 900, 1000, 1200, 1300, 1400, 1500, 1600, 1700, 1800, 1900, 2000, 2100, 2200, 2300) could be transformed into a year-round cat tower 102 for continued use, thus solving the issue of space required to store artificial Christmas trees (100, 200, 300, 400, 500, 600, 700, 800, 802, 900, 1000, 1200, 1300, 1400, 1500, 1600, 1700, 1800, 1900, 2000, 2100, 2200, 2300) between their seasonal use. This transformation may include a fully integrated cat tower structure, where branches are permanently attached and can be hinged for folding or compact storage, while still providing functional use as a cat tower.

Advantageously, the present invention facilitates the easy dismantling and storage of the artificial Christmas tree (100, 200, 300, 400, 500, 600, 700, 800, 802, 900, 1000, 1200, 1300, 1400, 1500, 1600, 1700, 1800, 1900, 2000, 2100, 2200, 2300). Additionally, the artificial Christmas tree (100, 200, 300, 400, 500, 600, 700, 800, 802, 900, 1000, 1200, 1300, 1400, 1500, 1600, 1700, 1800, 1900, 2000, 2100, 2200, 2300) integrated with the cat tower 102 allows cats to play on and within the tree (100, 200, 300, 400, 500, 600, 700, 800, 802, 900, 1000, 1200, 1300, 1400, 1500, 1600, 1700, 1800, 1900, 2000, 2100, 2200, 2300), thereby promoting interaction and engagement with pets. Furthermore, the present invention provides a means for users and pet owners to relax and enjoy the artificial Christmas tree (100, 200, 300, 400, 500, 600, 700, 800, 802, 900, 1000, 1200, 1300, 1400, 1500, 1600, 1700, 1800, 1900, 2000, 2100, 2200, 2300), enhancing the overall holiday experience. The artificial Christmas tree (100, 200, 300, 400, 500, 600, 700, 800, 802, 900, 1000, 1200, 1300, 1400, 1500, 1600, 1700, 1800, 1900, 2000, 2100, 2200, 2300) increases engagement between users and their pets by incorporating pets into the Christmas celebrations. Moreover, the artificial Christmas tree (100, 200, 300, 400, 500, 600, 700, 800, 802, 900, 1000, 1200, 1300, 1400, 1500, 1600, 1700, 1800, 1900, 2000, 2100, 2200, 2300) is repurposed for use as the cat tower 102, extending its utility beyond the holiday season and allowing it to be used for multiple years.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

What is claimed is:

1. An artificial Christmas tree, comprising:
a trunk comprises a climbing structure, wherein the climbing structure defines at least one pathway extending along at least a portion of a length of the trunk, wherein the pathway is dimensioned to allow at least one animal to move along or within the trunk, and
a decorative assembly configured to simulate at least one of the foliage, branches, and ornamental structures, wherein the decorative assembly is dimensioned to allow the at least one animal to access the pathway.

2. The artificial Christmas tree of claim 1, wherein the trunk is formed of at least one hollow member having at least one opening connected to the pathway, wherein the trunk comprises an interior side and an exterior side, wherein the pathway is defined on at least one of the interior side and the exterior side of the trunk, wherein the trunk is dimensioned to allow at least one animal to move over at least one of the interior side and the exterior side of the trunk via the pathway, wherein the decorative assembly is at least one of detachably attached to the trunk and integrally attached to the trunk, and wherein the climbing structure is at least one of detachably attached to the trunk and integrally attached to the trunk.

3. The artificial Christmas tree of claim 2, further comprises one or more of at least one platform disposed within the trunk, at least one platform disposed at an exterior side of the trunk, at least one platform disposed at least partially within the trunk, or any combination of arrangement thereof, wherein the platform comprises at least one of the opening and notches, and wherein the platform is at least one of detachably attached to the trunk and integrally attached to the trunk.

4. The artificial Christmas tree of claim 3, wherein the climbing structure comprises a pole disposed at the interior side of the trunk, wherein the pole extends at least partially along a length of the trunk, wherein the pole comprises at least one of a textured surface, protruded structures, recessed structures and a fabric layer, wherein the climbing structure comprises an extendable configuration, and wherein the pole is disposed at least one of detachably and integrally at the trunk.

5. The artificial Christmas tree of claim 4, further comprises a base at least partially connects the trunk and pole, wherein the trunk is at least one of detachably and integrally disposed above the base, wherein the pole extends at least one of detachably and integrally from the base within the trunk, and wherein the base extends to at least one of a periphery of the trunk and beyond the periphery of the trunk.

6. The artificial Christmas tree of claim 4, further comprises a base and the pole extends at least one of detachably and integrally from the base, wherein the trunk is arranged to enclose the base and the pole, and wherein a circumference of the base is less than the periphery of the trunk.

7. The artificial Christmas tree of claim 6, wherein the trunk further comprises a rim extending transversely from a bottom portion of the trunk.

8. The artificial Christmas tree of claim 3, further comprises a base and at least one leg disposed above the base, wherein the trunk comprises an elongated hollow body having two opposing end portions and a panel disposed at least one of detachably and integrally on at least one end portion, wherein the trunk is mounted at least one of detachably and integrally above the leg such that panel rests on the leg and positions the trunk at an elevated height relative to a ground surface, and wherein the leg is arranged at least one of detachably and integrally above the base.

9. The artificial Christmas tree of claim 3, wherein the trunk comprises an elongated hollow body having two opposing end portions and at least one panel disposed at least one of detachably and integrally on at least one opposing end portion, and wherein the panel is configured to at least partially close the opposing end portions.

10. The artificial Christmas tree of claim 9, wherein the artificial Christmas tree further comprises one or more legs extending at least one of detachably and integrally from the panel towards the exterior side of the trunk, wherein the legs are configured to support the trunk to stand in a vertical orientation.

11. The artificial Christmas of tree of claim 10, wherein the legs extend at least one of angular and perpendicular with respect to the panel.

12. The artificial Christmas tree of claim 1, wherein the climbing structure comprising at least one of fabric layer, poles, platforms, textured surface or any combination of arrangement thereof is formed on at least one of the interior side and exterior side of the trunk, and wherein the textured surface and the fabric layer is configured to enable the animal to climb along the length of the trunk.

13. The artificial Christmas tree of claim 1, wherein the climbing structure comprises at least one of protruded structures and recessed structures formed on at least one of the interior side and the exterior side of the trunk, and wherein at least one of the protruded structures and the recessed structure is configured to enable the animal to climb along the length of the trunk.

14. The artificial Christmas tree of claim 3, wherein a bottom portion of the trunk is configured to function as a base and enables the artificial Christmas tree to maintain a vertical orientation.

15. The artificial Christmas tree of claim 1, wherein the trunk is formed of one or more hollow members, wherein the hollow member having at least one opening, and
wherein the Christmas tree further comprises:
at least one platform disposed adjacent to the opening, wherein the platform is disposed on an exterior side of the hollow member, wherein the platform is at least one of detachably attached to the hollow member and integrally attached to the hollow member, wherein the platform is configured to encircle over at least a portion of the hollow member, and wherein the platform is configured as a flat surface to support the animal, and
one or more fastener members attached to at least one of an interior side and the exterior side of the hollow member, wherein at least one fastener member is at least one of detachably attached to the hollow member and integrally attached to the hollow member, wherein the fastener member is configured to attach the decorative assembly at least one of detachably and integrally to the tree, and wherein the fastener member comprises a plurality of apertures to receive and fasten the decorative assembly.

16. The artificial Christmas tree of claim 3, further comprises a base, and the trunk is disposed above the base, wherein the trunk is at least one of detachably attached to the base and integrally attached to the base, and wherein the base extends to at least one of a periphery of the trunk and beyond the periphery of the trunk.

17. The artificial Christmas tree of claim 1, further comprises a connecting member disposed at a top portion of the trunk to configured to detachably receive and position a corresponding connecting portion of the decorative assembly, wherein the connecting member is at least one detachably attached to the trunk and integrally attached to the trunk.

18. The artificial Christmas tree of claim 3, wherein at least one of the decorative assembly and the platform is at least one of detachably and integrally attached to a natural tree or an artificial tree.

19. An artificial Christmas tree, comprising:
a trunk comprises a climbing structure, wherein the climbing structure defines at least one pathway extending along at least a portion of a length of the trunk, wherein the pathway enables an animal to move along or within the length of the trunk, and wherein the climbing structure is at least one of detachably configured and integrally formed with the Christmas tree;
optionally, a pole disposed at the interior side of the trunk, wherein the pole extends at least partially along a length of the trunk;
optionally, a base, wherein the pole is at least one of detachably and integrally extends from the base, and
a decorative assembly configured to simulate at least one of the foliage, branches, and ornamental structures.

20. The artificial Christmas tree of claim 19, wherein the platform comprises at least one of holes and notches;
wherein the climbing structure comprises at least one of fabric layer, poles, platforms, textured surface or any combination of arrangement thereof;
wherein the pole comprises a plurality of pole sections, wherein the pole sections being at least one of integrally formed as a unitary structure and detachably connectable to one another, and wherein, when detachably connectable, one or more pole sections are selectively attachable and removable to adjust a height of the pole;
wherein the trunk comprises an elongated hollow body having two opposing end portions and a panel disposed on at least one end portion, wherein the elongated hollow body is formed of at least one hollow member, wherein the panel comprises at least one of holes and notches, wherein the panel is at least one of detachably and integrally arranged at the trunk;
wherein the foliage is arranged to define an area to support the animal for resting and maneuvering, and
wherein the decorative assembly is attached to at least one of platform, hollow member, hollow body and pole via a fastener member, wherein the decorative assembly is provided as at least one of an integral component and a detachably component.

21. An artificial Christmas tree, comprising:
a frame, and
a decorative assembly attached to the frame, wherein the decorative assembly is configured to simulate at least one of foliage, branches, and ornamental structures, wherein at least one of the frame and the decorative assembly defines a pathway, wherein the pathway extends at least a portion of a length of the frame, wherein the pathway is configured to enable an animal to move over or within the frame, wherein the decorative assembly is attached at least one of integrally and detachably to the frame.

22. The artificial Christmas tree of claim 21, wherein the frame comprises a plurality of beam portions, wherein the beam portion are interconnected to define an elongated tower, wherein the plurality of beam portions is connected to form openings distributed along the height of the frame, and wherein the openings collectively permit the animal to climb along the tower.

23. The artificial Christmas tree of claim 22, wherein one or more beam portions are interconnected to support one or more platforms to provide a space to support the animal, wherein the beam portions are at least one of detachably and integrally connected to one another, and wherein the platform is at least one of detachably and integrally connected to the beam portions.

24. The artificial Christmas tree of claim 21, wherein the frame comprises an elongated member and a plurality of platforms arranged over the elongated member, wherein the plurality of platforms is arranged spaced apart from one another, wherein the platforms are at least one of detachably and integrally connected to the elongated member, wherein at least one platform comprises at least one opening connected to the pathway, wherein the opening is dimensioned to allow passage of the animal, wherein the elongated member comprises a plurality of sections being at least one of integrally formed as a unitary structure and detachably connectable to one another, and wherein, when detachably connectable, one or more sections are selectively attachable and removable to adjust a height of the elongated member.

25. The artificial Christmas tree of claim 24, further comprises, optionally, one or more fastener members coupled to at least one of the elongated members and the platforms, wherein the fastener members are at least one of detachably and integrally coupled to at least one of the elongated members and platforms, wherein the fastener member is configured to at least one of detachably and integrally couple the decorative assembly to the frame, and wherein the platform comprises a body defining at least one of holes and notches.

26. The artificial Christmas tree of claim 24, wherein each of the plurality of platforms comprises a flat structure, wherein each platform has a circumference different from a circumference of another platform, and wherein the plurality of platforms is arranged along the elongated member to form a tapered configuration, wherein at least one platform comprises at least one of holes and notches, wherein the Christmas tree further comprises one or more fastener members coupled to at least one of the elongated members and the platforms, wherein the fastener members are at least one of detachably and integrally coupled to at least one of the elongated members and platforms, wherein the decorative assembly is at least one of integrally formed with or detachably coupled to the Christmas tree by the fastener member, and wherein the at least one platform extends beyond a structure of the Christmas tree.

27. The artificial Christmas tree of claim 21, further comprises at least one platform, wherein the platform is at least one of detachably and integrally coupled to the tree, wherein the platform extends beyond a structure of the Christmas tree.

28. The artificial Christmas tree of claim 21, wherein the frame comprises a base, a plurality of elongated members extending at least one of detachably and integrally from the base, and at least one platform supported by, coupled to, or disposed along the plurality of elongated members, and wherein the Christmas tree further comprises one or more fastener members coupled to at least one of the elongated members and the platforms, wherein the fastener member is configured to at least one of detachably and integrally couple the decorative assembly, and wherein the platform is at least one of detachably and integrally connected to the elongated member.
